(19) United States
(12) Patent Application Publication
(10) Pub. No.: US 2003/0126610 A1
(43) Pub. Date: Jul. 3, 2003

(54) IP streaming system, network router, IP-streaming set-top box, and IP streaming distribution method

(75) Inventor: Arata Ando, Fuchu-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/314,945

(22) Filed: Dec. 10, 2002

(30) Foreign Application Priority Data
Dec. 12, 2001 (JP) 2001-378698

(51) Int. Cl. H04N 7/173; G06F 15/16

(52) U.S. Cl. 725/91; 725/111; 709/219

(57) ABSTRACT

An IP streaming system includes a headend system which has a navigation server, a distribution server which distributes a content with a high viewing frequency as a broadcast content, and a management server which holds the frequency band information of CATV cables for distributing the broadcast content, and a CMTS which is connected to the system via a network and accommodates a CATV cable to which a user terminal is connected. The CMTS has a cable interface having the frequency band of the CATV cable for the broadcast content. After the user terminal requests the frequency band information of the CATV cable for the broadcast content from the management server and acquires it, tuning to the acquired frequency band of the CATV cable is done, thereby distributing the broadcast content from the distribution server to the user terminal.

### CROSS-REFERENCE TO RELATED APPLICATIONS

This application is based upon and claims the benefit of priority from the prior Japanese Patent Application No. 2001-378698, filed Dec. 12, 2001, the entire contents of which are incorporated herein by reference.

### BACKGROUND OF THE INVENTION

1. Field of the Invention

The present invention relates to an IP streaming system which performs IP streaming by using a CATV cable, a network router (to be referred to as a CMTS (Cable Modem Termination System) hereinafter), an IP-streaming set-top box (to be referred to as an IPB hereinafter), and an IP streaming distribution method.

2. Description of the Related Art

Recently, the two-way communication infrastructures using CATV have been improved, and IP streaming broadcasting of videos (moving pictures) and music has been done.

In the present invention, IP streaming indicates techniques in general which distribute contents such as videos and sounds in the form of IP packets by using an Internet protocol and reproducing the contents on the user side, and includes a pseudo IP streaming method of starting reproduction after storing part or all of contents temporarily in an HDD or the like on the user side.

According to a US broadcasting system which performs broadcasting on cables using analog terrestrial waves, frequencies are used in the range of 50 MHz through 450 MHz on CATV cables. In this case, a band of about 6 MHz is used per channel.

When data communication is performed by using Cable Infrastructure, a frequency band other than the frequency band from 50 MHz to 450 MHz, e.g., the frequency band from 500 MHz to 600 MHz, is used. In this case, the data is modulated by using QAM (Quadrature Amplitude Modulation) technique, which is digital modulation. In addition, a tuner implemented in an IP-streaming-compatible equipment such as a CMTS or IPB (IP-streaming set-top box) is tuned at each 6-MHz band. This QAM scheme allows transmission of many data within a narrow band by simultaneously modulating the amplitude and phase of a sine carrier wave, which are two of its parameters, i.e., amplitude, phase, and frequency. The QAM schemes mainly used in Cable Infrastructure are the 64-QAM scheme and 256-QAM scheme. In the case of the 64-QAM scheme, for example, a transmission band of about 27 Mbps can be obtained at a single 6 MHz band. Currently, data communication services have been provided in the way that many users share a transmission band of 27 Mbps.

This system includes a headend system which stores many types of multimedia contents and executes distribution processing of contents in accordance with viewing requests from users, a ring topology network, and a plurality of distribution HUBs. Many user terminals each constituted by an IPB and television (TV) are connected to CATV cables accommodated in the respective distribution HUBs.

This headend system includes a navigation server which incorporates an EPG (Electronic Program Guide) which becomes an electronic menu window that can be browsed, a navigation server mechanism, and the like, provides the EPG in accordance with a menu window request from a user, receives the type of content which the user wants to view, and sends a distribution request notification, a distribution server which includes a large-capacity distribution information database storing many types of multimedia contents, the band information and necessary distribution time information required to distribute the respective contents, and other information required for distribution, manages distribution information including various types of contents, and distributes a content to a user upon reception of a distribution request notification from the navigation server, a management server which holds configuration files to notify the IPB of the IP addresses of the navigation server and distribution server, and a router which forms a routing table on the basis of a routing protocol and propagates IP packets.

The network is typically an optical ring which connects a headend system accommodating various types of servers explained above and many distribution HUBs accommodating CMTSs installed at remote places.

This CMTS is basically a router which has an RF (Radio Frequency) interface and the same function as that of a router. An IPB (IP streaming set-top box) has the function of receiving an IP packet of a requested streaming content, decoding upper-protocol level content video and sound data, e.g., contents in these streaming packets by using a CODEC (coder/decoder), and displaying the decoded data on a television (TV).

In distributing contents by using a conventional IP streaming technique, however, if a plurality of users request the same content, transmission bands must be reserved on CATV cables for the respective users, consuming a band equal to a multiple of the number of users. That is, the each CATV band cable cannot be efficiently used.

Furthermore, since the frequency band of a CATV cable is limited, it is difficult to reserve a band for the provision of a VOD (Video On Demand) service or the like. This results in restrictions on the number of users to which the VOD service is to be simultaneously provided and the like.

### BRIEF SUMMARY OF THE INVENTION

It is an object of the present invention to provide an IP streaming system, network routers, IP streaming set-top box, and IP streaming distribution method which realize the effective use of frequency bands on CATV cables.

It is another object of the present invention to provide an IP streaming system, network routers, IP streaming set-top box, and IP streaming distribution method which realize their use with higher extensibility by removing restrictions from frequency bands on CATV cables.

(1) In order to solve the above problems, according to the present invention, there is provided an IP streaming system which includes a user terminal which generates a viewing request for a content, and performs IP streaming of a content for the user terminal via a CATV cable, comprising a distribution server which holds a content and distributes the content, and a CMTS which has a broadcast cable interface to which a frequency band of the CATV cable for distributing the content is assigned and propagates the content distributed from the distribution server to the user terminal.

With this arrangement of the present invention, since the user terminal requests the frequency band information of broadcasting from the management server and tunes to the acquired frequency band of the CATV cable, broadcast contents can be distributed while the frequency band of the CATV cable is effectively used.

(2) An IP streaming server according to the present invention includes a distribution server which distributes a content and a CMTS which distributes the content distributed from the distribution server to a user terminal. This distribution server includes frequency checking means for, when a viewing request for a VOD content is generated from the user terminal, checking an operating frequency currently used by the user terminal, which has generated the viewing request, by using an RSVP (Resource Reservation Protocol) message, and the like and the CMTS includes means for, on the basis of a check result on the operating frequency of the user terminal which is obtained by the distribution server, assigning a frequency different from the checked operating frequency to the VOD cable interface, and distributing the VOD content distributed from the distribution server to the user terminal which has generated the viewing request. In addition, the CMTS has the function of assigning an operating frequency to the VOD cable interface on the basis of the contents of the RSVP message received from the user terminal in the opposite direction to the RSVP message from the distribution server.

With the above arrangement of the present invention, when the user terminal generates a request to view a VOD content, tuning to the frequency band provided by the VOD cable interface is performed, and the VOD content is distributed from the distribution server to the user terminal as the viewing request source. This makes it possible to remove restrictions on the frequency band on a CATV cable and realize a system with higher extensibility.

Note that since the CMTS changes its frequency band to a different frequency band on the basis of the contents of an RSVP message, and the like received from the user terminal in the opposite direction to an RSVP message from the distribution server, restrictions on the frequency band on a CATV cable can be removed, and a system with higher extensibility can be realized.

(3) According to the present invention, there are provided network routers installed between distribution servers which hold and distribute broadcast contents and VOD contents and user terminals which receive the content distributed from the distribution servers via CATV cables, comprising a broadcast cable interface which is assigned a frequency band for distributing the broadcast content, a VOD cable interface which is assigned a frequency band for distributing the VOD content, first distribution means for distributing the broadcast content distributed from the distribution server in advance to the user terminal, on the basis of a viewing request from the user terminal, to the user terminal which has generated the viewing request via the broadcast cable interface, and second distribution means for, when a viewing request for a VOD content is generated from the user terminal, assigning the VOD cable interface a frequency band different from an operating frequency band of the user terminal which has generated the viewing request which has been checked by the server, and distributing via the VOD cable interface the VOD content to the user terminal which has generated the viewing request.

With the above arrangement of the present invention, the network router can distribute a content with a high viewing frequency which is received from the distribution server as a broadcast content to the user terminal. In addition, when a request to view a VOD content is received from the same user terminal, the network relay apparatus distributes the VOD content upon changing the frequency band. This makes it possible to provide a VOD service while removing restrictions on the frequency band of a CATV cable.

(4) According to the present invention, there is provided a set-top box in an IP streaming system including a distribution server which holds a content and distributes the content, a management server which holds frequency band information of a CATV cable for distributing the content, a network router, and a CATV cable, the set-top box receiving the content distributed via the network router and the CATV cable, comprising interface means between the set-top box and the network router, tuning means for, when the content is to be viewed by broadcasting, acquiring, from the management server, a frequency band of the CATV cable for distributing the content to be viewed by broadcasting, and tuning the interface means to the acquired frequency band, and changing means for, when the content is to be viewed by VOD, changing a frequency band to which the interface is to be tuned to a frequency band different from a frequency set when the content is viewed by broadcasting.

With the above arrangement of the present invention, broadcast contents can be easily viewed while the frequency band of a CATV cable is effectively used when a VOD service request is generated. In addition, the user terminal can receive a VOD service without being limited by the frequency band of the CATV cable which is used for the distribution of a broadcast content.

(5) According to the present invention, there is provided an IP streaming distribution method in an IP streaming system which includes a distribution server which holds a content and distributes the content, a management server which holds frequency band information of a CATV cable for distributing the content, a navigation server which provides a menu for the content, a network router, a CATV cable, and a user terminal which receives the content distributed via the network router and the CATV cable, comprising the steps of, when the user terminal generates a request to view a content which is being broadcasted, providing frequency band information for broadcasting from the management server to the user terminal, and setting the user terminal in a state in which the user terminal can communicate with the network router on the basis of the provided frequency and for broadcasting, when the user terminal generates a request for a menu for the content, providing the menu from the navigation server to the user terminal, and when the user terminal designates a content to be viewed on the basis of the menu, distributing the designated content to the user terminal via the network router and the CATV cable.

In this IP streaming distribution method, as described above, a content with a high viewing frequency can be distributed as a broadcast content to many users by unicasting while the frequency band of a CATV cable is effectively used in the same manner as described above.

(6) According to the present invention, there is provided an IP streaming distribution method in an IP streaming system which includes a distribution server which holds a content and distributes the content, a management server which holds frequency band information of a CATV cable for distributing the content, a navigation server which holds a menu for the content and provides a corresponding message, a network router, a CATV cable, and a user terminal which receives the content distributed via the network router and the CATV cable, comprising the steps of, when the user terminal generates a request for a menu for the content, providing the menu from the navigation server to the user terminal, when the user terminal generates a request to view a VOD content on the basis of the menu, causing the navigation server to give the distribution server a request to distribute the content, causing the network router to reserve an operating frequency band for the CATV cable on the basis of a return message returned from the user terminal which has received the RSVP message from the distribution server which has received the distribution request, notifying that the network router changes a frequency band used for the user terminal to the reserved operating frequency band, and notifying the distribution server of reservation of the frequency band, and causing the distribution server, which has received notification of reservation of the frequency band, to distribute a VOD content for which the viewing request has been received to the user terminal which has generated the viewing request.

In this IP streaming distribution method, a content distribution method with higher extensibility can be realized by removing restrictions on the frequency band on a CATV cable in the same manner as described above.

Additional objects and advantages of the present invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention.

FIG. 1 is a system diagram of an embodiment of an IP streaming system according to the present invention;

FIG. 2 is a block diagram showing the arrangement of an embodiment of a CMTS in FIG. 1;

FIG. 3 is a block diagram showing an embodiment of an IPB in FIG. 1;

FIG. 4 is a distribution flow diagram for explaining the distribution of a broadcast content;

FIG. 5 is a content distribution flow diagram for explaining the distribution of a VOD content;

FIG. 6 is a detailed flow diagram for explaining a frequency changing step (F) in FIG. 5; and

FIG. 7 is a flow diagram for explaining the operation of a CMTS.

### DETAILED DESCRIPTION OF THE INVENTION

An embodiment of the present invention will be described below with reference to the several views of the accompanying drawing.

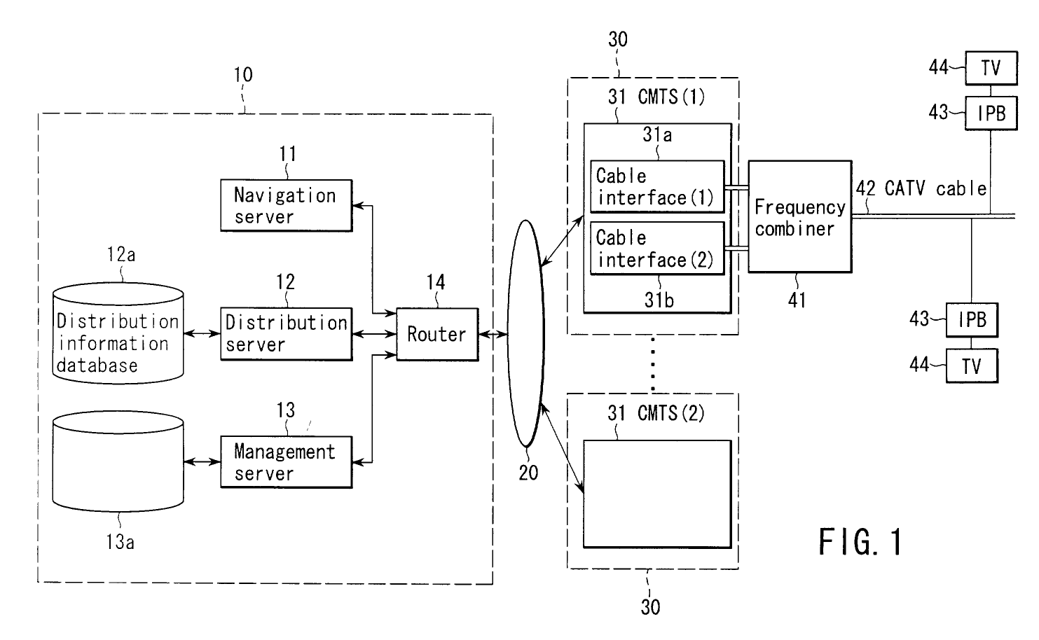

FIG. 1 is a system diagram of an embodiment of an IP streaming system according to the present invention.

In this IP streaming system, a content with a high viewing frequency is broadcast to allow a plurality of users to view the same content, so the resources of a network, more particularly the frequency band on a CATV cable, is changed to a frequency band different from the frequency band used for broadcast distribution as needed, thereby removing restrictions from the frequency band of the CATV cable.

More specifically, this IP streaming system includes an headend system 10 which stores many types of multimedia contents and executes distribution processing of multimedia contents such as videos for which viewing requests are sent from users, a network 20 having, for example, a ring-topology configuration, and a plurality of distribution HUBs 30.

A CATV cable 42 is connected to each distribution HUB 30 via a frequency combiner 41. Many user terminals each constituted by an IPB 43 and television (TV) 44 are connected to this CATV cable 42.

The headend system 10 includes a group of servers such as a navigation server 11, distribution server 12, and management server 13, and also has a router 14 which forms a routing table on the basis of a routing protocol and propagates IP packets sent from the serves and network 20. This router 14 supports a multicast protocol.

This navigation server 11 incorporates an EPG (Electronic Program Guide) which becomes a menu window which is possessed by the server 11 itself and can be browsed, navigation server software, other necessary software, and the like, and executes required processing while securing cooperation among the EPG and various pieces of software. When a request to view a given content is sent from a user, the navigation server 11 receives the type of requested content. If a VOD content is requested, the navigation server 11 notifies the distribution server 12 of the corresponding information. Assume that the requested content is distributed by broadcasting, the navigation server 11 does not notify the distribution server 12.

This distribution server 12 has a large-capacity distribution information database 12a which stores many types of multimedia contents, band information and necessary distribution time information required to distribute the respective contents, and other information required for distribution, and has the function of managing distribution information including various types of contents. Upon reception of a distribution request for a VOD content from the navigation server 11 on the basis of request source information such as an IP address, the distribution server 12 reads out the requested content from the distribution information database 12a, and distributes to the user on the basis of the request source information. In contrast, a broadcast content is distributed by using a multicasting technique such as IP multicasting. Note that a broadcast content is set in advance on the basis of the use frequency in the past or a use frequency is set in advance and a content whose use frequency exceeds the reference use frequency is automatically recognized as a broadcast content. Alternatively, such contents are determined in accordance with a contract with a contents provider.

The management server 13 includes a storage means 13a which holds configuration files having information such as the IP addresses of the navigation server 11 and distribution server 12 and the frequency band of the CATV cable 42 through which contents are broadcast, and has the function of notifying the IPB 43 of information such as the frequency of a CATV cable 52, through which an IP address and content are broadcast, by transmitting a configuration file upon reception of a file request from the IPB 43.

The network 20 is a transmission line formed from a ring-topology optical fiber which connects the headend system 10 accommodating the respective servers 11, 12 and 13 required to execute streaming distribution to many distribution HUBs 30 accommodating CMTSs 31 installed at many places. Note that the network 20 need not have a ring-like shape and is not limited to an optical fiber.

Note that if the number of CMTS 31 is small, e.g., one, it may be included in the headend system 10. In this case, a system including the CMTS 31 will be referred to as a headend system.

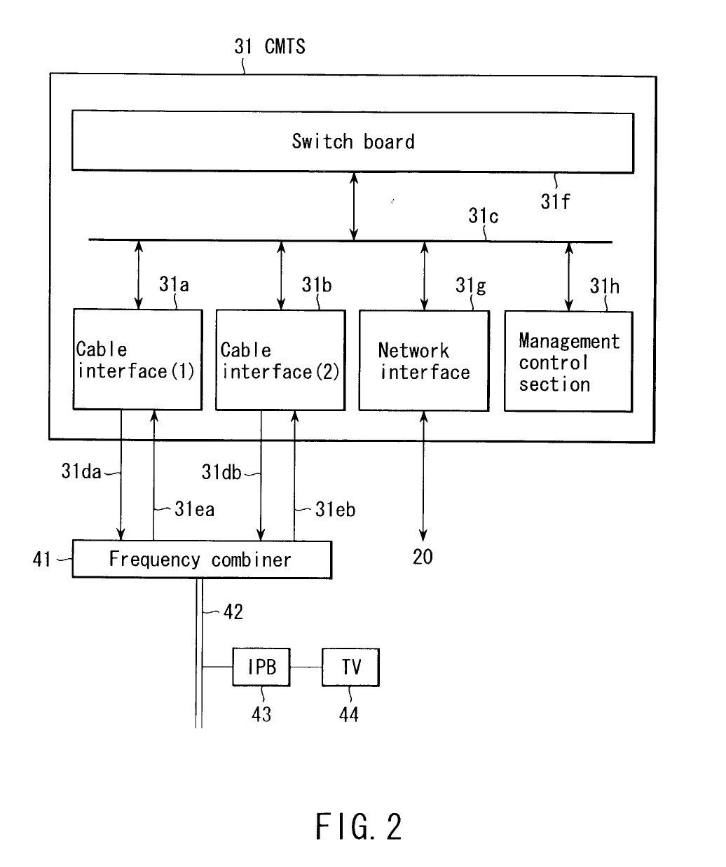

This CMTS 31 is a kind of router having a function similar to that of the router 14 having a cable interface (RF interface). The CMTS 31 has the functions of acquiring a frequency band used for each interface by using a protocol such as RSVP (Resource Reservation Protocol) transmitted from the distribution server 12 and supporting IP multicasting and a protocol that allows a client (corresponding to the IPB 43) to participate in or leave a multicast group, e.g., IGMP (Internal Group Management Protocol). For example, the CMTS 31 has the arrangement shown in FIG. 2.

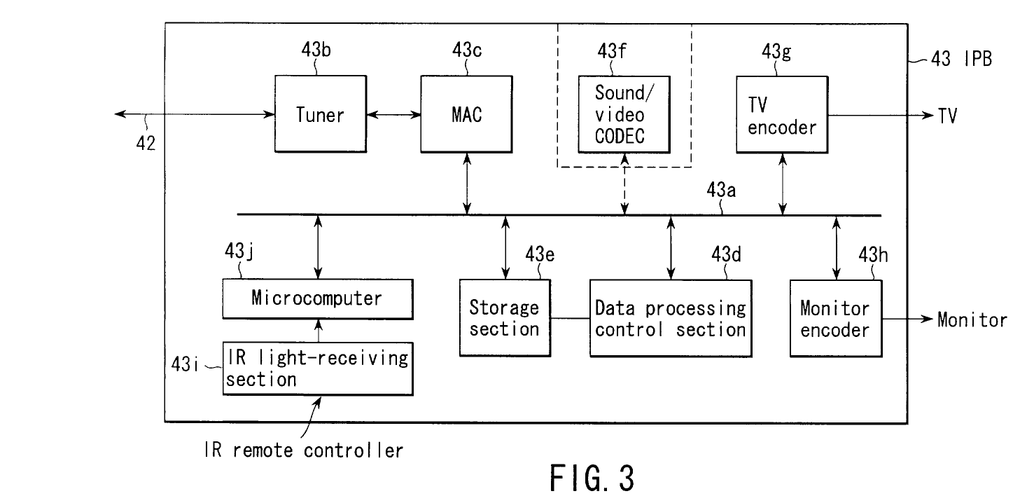

The IPB (IP-streaming set-top box) 43 receives an IP packet containing a content for which a viewing request is generated, decodes upper-protocol level data video and sound data, e.g., an application contained in this IP packet by using a CODEC (coder/decoder), and displays the decoded data on the television (TV) 44. The IPB 43 also has the function of supporting IGMP. For example, the IPB 43 has the arrangement shown in FIG. 3.

FIG. 2 is a block diagram showing the arrangement of an embodiment of the CMTS 31 used in the system according to the present invention This CMTS 31 includes a broadcast content cable interface 31a to which a frequency band for broadcast contents is assigned in advance, and a VOD service cable interface 31b to which a frequency band for a VOD service is assigned. These interfaces 31a and 31b respectively have ports corresponding to downstream cables 31da and 31db and upstream cables 31ea and 31eb.

A switch board 31f, an interface 31g corresponding to the network 20, and a management control section 31h formed from a CPU are connected to an internal switch bus 31c. The switch board 31f has a switching function that enables routing communication between the headend system 10 and each IPB 43.

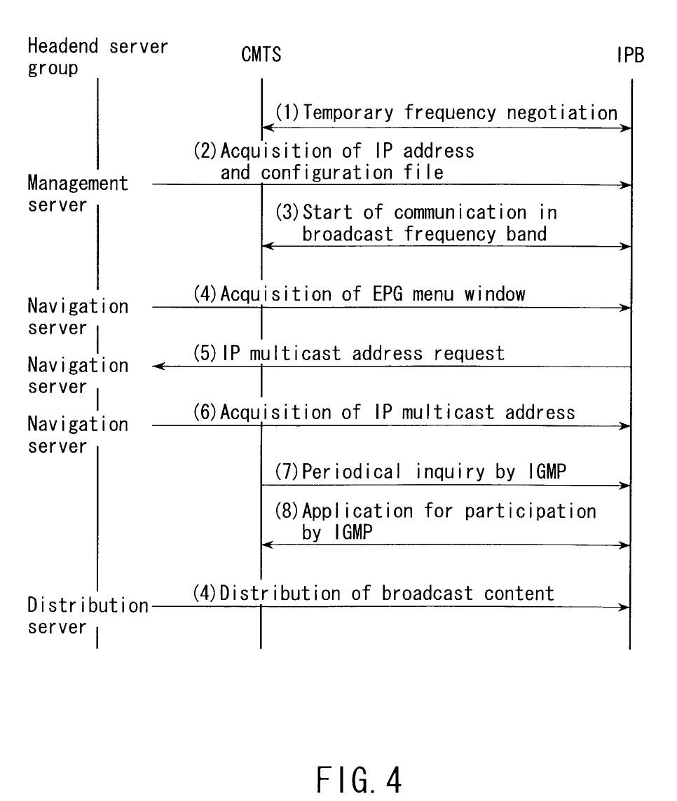

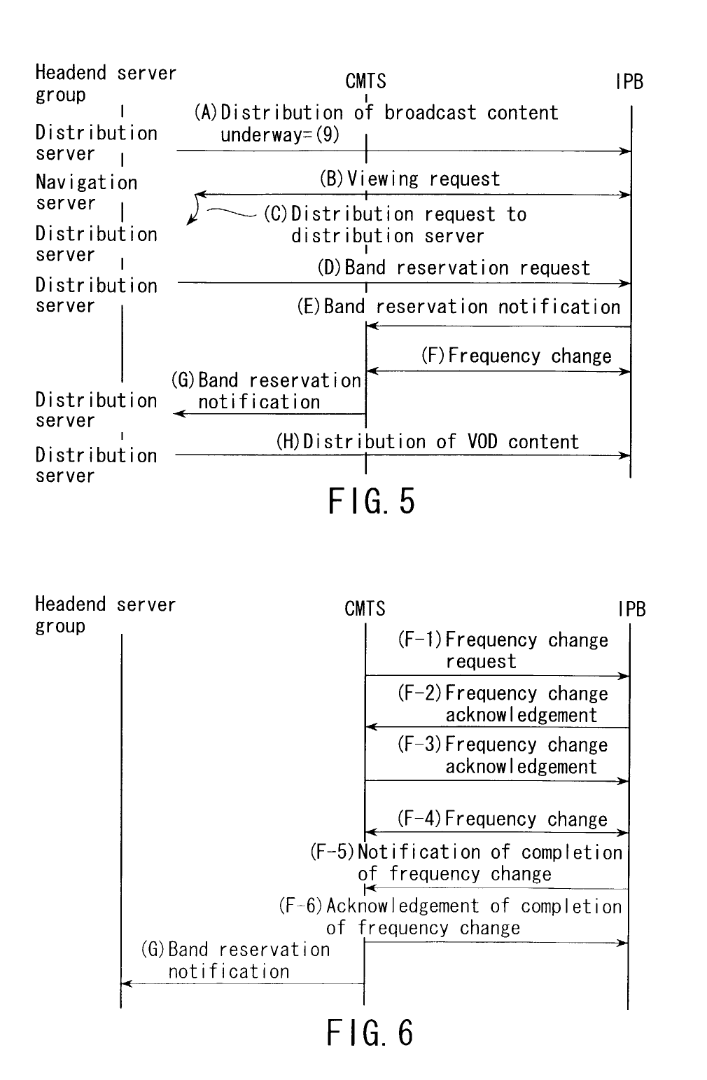

The management control section 31h is a CPU board, which executes necessary statistical processing, the processing of grasping the frequency band states of the respective interfaces 31a and 31b from messages when RSVP (Resource Reservation Protocol) transmitted from the distribution server 12 is used and changing the frequency bands to different frequency bands, processing of IP packets addressed to the home CMTS, and other necessary processing shown in FIGS. 4 and 5 (to be described later).

That is, the CMTS 31 roughly has the following two functions. The first function is to propagate the broadcast content distributed from the distribution server 12 by using an IP multicast protocol via the cable interface 31a dedicated to broadcasting in accordance with a viewing request from a user terminal.

The second function works as follows. Assume that a viewing request for a VOD content is sent from a user terminal. In this case, if the user terminal that has sent the viewing request has already viewed a broadcast content, this function serves to instruct the user terminal to tune (change the frequency) to the VOD service cable interface 31b. Assume that the user terminal that has sent the viewing request has already viewed another VOD content. In this case, if many bands (transmission bands) are required for the distribution of VOD contents for which viewing requests are newly generated, and no band (transmission band) is left which can be used by the currently used VOD service cable interface 31b, the function serves to instruct the user terminal to tune (change the frequency) to another VOD service cable interface (not shown) upon switching from the VOD service cable interface 31b currently used to view the VOD content. Upon completion of tuning of the user terminal, the function serves to relay the VOD content for which the viewing request has been generated by using the new cable interface to which the user terminal has tuned.

Note that if the user terminal which has generated the viewing request has already viewed another VOD content, the second function serves to relay the VOD content for which the viewing request has been generated by using the VOD service cable interface 31b which has already used the band (transmission band), required for the distribution of the VOD content for which the new viewing request has been generated, for the VOD content that has already been viewed.

FIG. 3 is a block diagram showing an embodiment of the IPB (IP-streaming set-top box) 43. This IPB 43 can cope with changes in frequency upon the IP broadcast distribution and VOD contents distribution (to be described later) shown in FIGS. 4 and 5, respectively.

More specifically, the IPB 43 includes an internal bus 43a, to which the following components are connected: a tuner 43b and MAC (Media Access Control) 43c connected to the CATV cable 42, a data processing control section 43d formed by a CPU, a storage section 43e, and a sound/video CODEC 43f. In addition, a TV encoder 43g for the television (TV) 44, a monitor encoder 43h for a CRT monitor or the like, and a microcomputer 43j which receives control information sent from an external remote controller via a light-receiving section 43i and performs predetermined processing for the information are connected to the internal bus 43a.

The tuner 43b has the function of negotiating with a cable interface 41a of the CMTS 31 to reserve a frequency band for communication so as to enable transmission/reception of various pieces of information.

The MAC 43c is a MAC chip for a CATV system. The receiving side of the MAC 43c has the function of receiving a cable MAC frame from the tuner 43b and transmitting an IP packet to the internal bus 43a. The transmitting side of the MAC 43c has the function of forming the IP packet transmitted from the internal bus 43a into a capsule in the cable MAC format and transmitting it to the tuner 43b.

The data processing control section 43d has the function of executing transmission/reception processing of control IP packets, decoding of video/image contents, and various kinds of application processes, and the operation of a real-time OS that executes control in real time with respect to these processes.

The storage section 43e stores programs for the data processing control section 43d, and serves as a buffer for IP packets to be transmitted/received to/from the cable MAC 43c, a buffer for image data, and the like.

The sound/video CODEC 43f decodes IP packet data which are the encoded sound/video contents to be stored in the storage section 43e. Such data can also be decoded by software operating on the data processing control section 43d and storage section 43e. A conventional IP-streaming set-top box is based on MPEG2 and hence generally uses a hardware decoder. However, many IP streaming systems use software decoders. In this case, the data processing control section 43d executes the function of a software CODEC. In this case, the sound/video CODEC enclosed with the dashed line is not required.

The TV encoder 43g changes the format of a video content to the NTSC or PAL format, and transmits the resultant content to the television (TV) 44.

The light-receiving section 43i receives information generated from the external remote controller which indicates, for example, a change in channel, power on/off, or selection/designation, i.e., an IR serial stream, and transmits it to the microcomputer 43j. The microcomputer 43j then decodes this information and transmits it to the internal bus 43a.

This IPB 43 operates as follows. The encoded video/sound content formed into an IP packet and distributed from the distribution server 12 is stored as an IP packet in the storage section 43e via the tuner 43b, MAC 43c, and internal bus 43a. This IP packet is disassembled into an encoded video/sound content as user data in the storage section 43e. If a hardware CODEC is used as the sound/video CODEC 43f, the content is transferred to the sound/video CODEC 43f. The data decoded by the sound/video CODEC 43f is then stored in the storage section 43e. The stored data is transferred to the TV encoder 43g or monitor encoder 43h to be displayed on the television (TV) 44 or monitor.

An embodiment of an IP streaming distribution method based on broadcasting according to the present invention which uses the above system will be described next (see FIG. 4).

A preparation for distribution in the distribution server 12 will be described first. Prior to the distribution of a content by broadcasting, the distribution server 12 reserves an actual band for an IP multicast stream in the CMTS 31 and another network router by using a protocol such as RSVP (Resource Reservation Protocol) as in the case of general IP streaming distribution, and distributes the content.

The broadcast content from the distribution server 12 is distributed by using a multicasting technique such as IP multicasting. With regard to the number of channels, when, for example, digital modulation is to be done by the 64-QAM scheme, the transmission rate in a 6-MHz frequency band, which is correspond to a band of analog TV becomes 20 Mbps in consideration of the IP protocol overhead. Consider the band required for each channel. If the transmission rate is 500 kbps, 20 Mbps÷500 kbps=40 channels can be reserved. However, since a slight band is required for communication, for example, 30 streams can be distributed by using 30 different IP multicast group addresses.

The IP multicast streams are distributed to the CMTS 31 via the router 14. This CMTS 31 propagates the IP multicast streams to only the IPBs 43 which want to participate in a multicast group located downstream of the CMTS 31 itself on the basis of IGMP.

The distribution of broadcast contents will be descried in detail next. Note that numbers (1), (2), . . . in the following description correspond to numbers (1), (2), . . . shown in the flow of FIG. 4.

(1) When the IPB 43 is powered on, a negotiation is started between the IPB 43 and, for example, the cable interface 31a of the CMTS 31 to acquire a temporary frequency band for initial communication. As a result, a temporary frequency band for the execution of communication between the IPB 43 and the cable interface 31a of the CMTS 31 is determined.

(2) The IPB 43 then requests and acquires a configuration file or the like from the management server 13 on the basis of the request source information of the IP address of the IPB 43 itself. This configuration file contains the IP address of the navigation server 11, frequency band information on the CATV cable 42 for a broadcast content, and the like. If the IP address, the frequency band information on the CATV cable 42 for a broadcast content, and the like are written in a file different from the configuration file, a request for this file is generated independently of the configuration file acquisition process to acquire the IP address of the navigation server 11, the frequency band information on the CATV cable 42 for the broadcast content, and the like.

The IPB 43 re-tunes to the frequency band for the broadcast content which is acquired by the CMTS 31, and executes data communication by using an available area in the band for the broadcast content.

These steps (2) and (3) correspond to the broadcast frequency band communication reservation step.

(4) When the IPB 43 requests an electronic menu window which is an EPG, the navigation server 11 provides the EPG as a menu window held by itself to the IPB 43. This EPG menu window displays select buttons for channels through which broadcast contents are currently distributed, VOD movies classified into different categories, and the like. Step (4) corresponds to the menu window providing step.

(5) When the user selects a broadcast channel from the EPG menu window, request information for an IP multicast group address is transmitted from the navigation client software of the IPB 43 to the navigation server 11.

(6) The navigation server 11 notifies the channel IP multicast group address requested by the IPB 43. Note that this IP multicast group address can also be transmitted to the IPB 43 upon generation of an EPG menu window request.

These steps (5) and (6) correspond to the group address notification step.

(7) Since a broadcast content has already been distributed from the distribution server 12 to the CMTS 31 in this period, the CMTS 31 has periodically inquired the IPBs 43 using IGMP whether they have participated in the respective IP multicast groups (30 IP multicast groups in this case).

(8) In order to acquire the address of a desired IP multicast group, the IPB 43 notifies the CMTS 31 by using IGMP that the IPB 43 will participate in the group. These steps (7) and (8) correspond to the group participation request step.

This CMTS 31 starts relaying the broadcast content for which the viewing request has been generated to the CATV cable 42 to which the IPB 43 which has generated, the participation request is connected. The user can therefore view the broadcast content. This step (9) corresponds to the broadcast contents distribution step.

An embodiment of an IP streaming distribution method for VOD contents according to the present invention which uses the system shown in FIG. 1 will be described next (see FIG. 5).

In this case, while the user is viewing a broadcast distributed content, the IPB 43 is tuned to another VOD frequency band to allow the user to view a VOD content.

(A) The IPB 43 is viewing the broadcast content distributed from the distribution server 12 as described in step (9).

(B) Since the IPB 43 is holding an EPG menu window in its memory or HDD 43E, the IPB 43 starts the EPG menu window. In general, the user operates a button provided in the IPB itself or a remote controller to cause an interrupt in the data processing control section 43d, thereby starting the EPG menu window. When the user selects a VOD content such as a movie from the displayed EPG menu window, the IPB 43 transmits viewing request information to the navigation server 11 on the basis of request source information such as an IP address.

(C) Upon reception of the viewing request information, the navigation server 11 transmits the request source information (distribution destination information) and the name of the content for which the viewing request has been generated, and requests distribution from the distribution server 12.

These steps (B) and (C) correspond to the VOD distribution request step.

(D) The distribution server 12 generates a request to reserve a band for a route to the IPB 43 as the viewing request source by using an existing protocol such as RSVP. In generating a request to reserve a band, the distribution server 12 transmits a path message by using an existing protocol such as RSVP to check whether a VOD content can be distributed by using a network resource (a bandwidth that can be reserved or the maximum packet length) of a route to the user who has generated the viewing request. If no error occurs, the path message arrives at the IPB 43 finally. The IPB 43 therefore reserves a bandwidth to receive the VOD content.

(E) If the contents distribution capacity is appropriate, the IPB 43 transmits a resv message based on RSVP in the opposite direction to the path message to notify the CMTS 31 of the reservation of a band for an actual path. These steps (D) and (E) correspond to the VOD band reservation step.

(F) Step (E) corresponds to the bandwidth reservation step to receive the VOD content.

(F) Upon reception of the resv message transmitted from the IPB 43, the CMTS 31 determines that a bandwidth for the actual path is reserved, changes the cable interface 31b to be used between itself and the IPB 43. This step (F) corresponds to the frequency changing step. That is, in step (F), the frequency to be used for the distribution of a VOD content is changed. This operation will be described with reference to FIG. 6.

(G) When the frequency changing operation between the CMTS 31 and the IPB 43 is completed in accordance with the frequency changing flow in FIG. 6, the CMTS 31 notifies the distribution server 12 of the reservation of the bandwidth.

(H) The distribution server 12 actually starts distributing a VOD content. These steps (G) and (H) correspond to the VOD contents distribution step.

The frequency changing operation described in step (F) will be described in detail below with reference to FIG. 6.

(F-1) Upon reception of a resv message from the IPB 43, the CMTS 31 sends a frequency change request to the IPB 43, together with a new frequency band.

(F-2) In order to notify the reception of the frequency change request, the IPB 43 transmits a frequency change acknowledgement to the CMTS 31.

(F-3) In order to notify the reception of the frequency change acknowledgement, the CMTS 31 transmits a frequency change acknowledgement to the IPB 43.

These steps (F-1) through (F-3) correspond to the frequency change acknowledgement step.

(F-4) The IPB 43 re-tunes to the frequency notified in step (F-1). At this time, in practice, the IPB 43 starts communicating with the cable interface 31b different from the one with which the IPB 43 has communicated so far. Re-tuning is done by using the management message periodically issued by the cable interface 31b of the CMTS 31 in the same manner as the cable interface 31. This step (F-4) corresponds to the tuning step on the user side.

(F-5) The IPB 43 transmits a frequency change end notification to the CMTS 31 upon completion of re-tuning.

(F-6) In order to notify the reception of the frequency change end notification, the CMTS 31 transmits a frequency change end acknowledgement to the IPB 43. These steps (F-5) and (F-6) correspond to the frequency change end acknowledgement step.

As described in step (G), the CMTS 31 notifies the distribution server 12 of the reservation of the band to notify the completion of bandwidth reservation.

In the above embodiment, frequency changing operation is executed by extensively using RSVP protocol. However, the present invention may use a scheme which additionally has, on the headend system 10 side, a policy server which has a database and manages the resources existing in network paths to the respective user terminals and the frequency band in the overall system, and performs frequency changing operation by the cooperation between the distribution server 12 and the policy server.

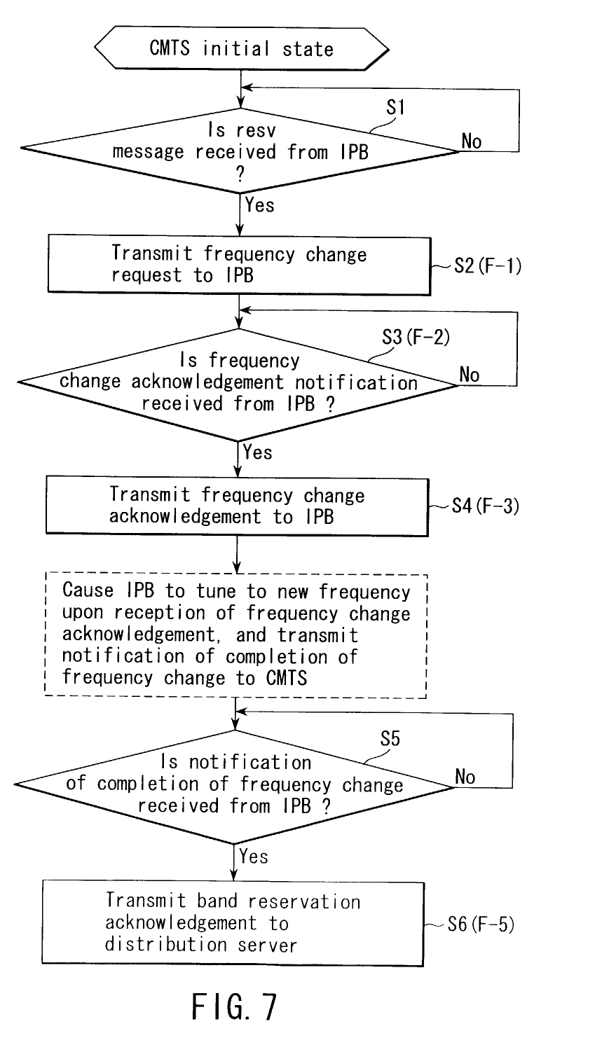

The operation of a CMTS concerning frequency changing operation will be described next with reference to FIG. 7.

On the basis of the path message transmitted from the distribution server 12 by using RSVP protocol, the CMTS 31 checks whether an resv message (a message notifying that a bandwidth is reserved) based on RSVP from the IPB 43 (S1; see E in FIG. 5). Upon determining that the resv message is received, the CMTS 31 transmits a frequency change request to the IPB 43 (S2; see F-1 in FIG. 6).

Subsequently, the CMTS 31 checks whether a frequency change acknowledgement notification is received from the IPB 43 (S3; see F-2 in FIG. 6). Upon determining that a frequency change acknowledgement notification is received, the CMTS 31 transmits a frequency change acknowledgement to the IPB 43 (S4; see F-3 in FIG. 6). The IPB 43 which has received the frequency change acknowledgement tunes to the new frequency and then transmits a frequency change end notification to the CMTS 31.

The CMTS 31 checks whether a frequency change end notification is received from the IPB 43 (S5; see F-5 in FIG. 6). Upon determining that the end notification is received, the CMTS 31 notifies the distribution server 12 that a bandwidth is reserved (S6).

According to the above embodiment of the IP streaming system, therefore, when the IPB 43 requests and acquires frequency band information for the distribution of a broadcast content containing the IP address of the navigation server 11 from the management server 13 which holds the frequency band information of the CATV cable 42 through which the broadcast content is transmitted, the IPB 43 tunes to the acquired frequency band of the CATV cable. This allows the content to be distributed to the IPB 43 which is the request source. Since a content with a high viewing frequency can be distributed to a plurality of users within the frequency band on a single CATV system, contents can be distributed by effectively using the frequency band of the CATV cable.

When a request to view a VOD content is generated from the IPB 43, the CMTS 31 checks the frequency band actually used by the IPB 43. The CMTS 31 then assigns another frequency band to the VOD service cable interface 31b, and distributes the VOD content from the distribution server 12 to the IPB 43 which is the viewing request source. This makes it possible to distribute VOD contents without being limited by restrictions on the frequency band of the CATV cable, thereby realizing a system with high extensibility.

In addition, the CMTS 31 transmits an RSVP message from the distribution server 12. Upon reception of this RSVP message, the IPB 43 transmits an RSVP message in the opposite direction. The CMTS 31 can grasp the frequency to be used from the RSVP message from the opposite direction. The VOD service cable interface 31b can be used after a different frequency band is assigned to it, thereby realizing a system with high extensibility without the influences of restrictions on the frequency band of the CATV cable.

Furthermore, the CMTS 31 includes, for example, the broadcast cable interface 31a which is assigned the frequency band of a CATV cable through which a broadcast content is supplied, and the VOD service cable interface 31b. The network router 31 is arranged to distribute a content to the IPB 43 when the IPB 43 is viewing the broadcast content which has already been transmitted from the distribution server 12. When a VOD content viewing request is generated from the IPB 43, the network router 31 assigns a frequency band different from that currently used by the user terminal to the VOD service cable interface 31b, and distributes the VOD content received from the distribution server 12 to the IPB 43 which is the viewing request source. With this arrangement, the broadcast contents transmitted from the distribution server 12 can be distributed to a plurality of users in a single frequency band. In addition, when a VOD content viewing request is received from the same IPB 43, the frequency band on the CATV cable is changed, and a VOD content is distributed. This makes it possible to provide VOD services without being influenced by restrictions on the frequency band of the CATV cable.

In addition, when the IPB (IP-streaming set-top box) 43 acquires the frequency band information of a CATV cable, through which broadcast contents are supplied, from a management server installed on the headend system side which holds the frequency band information, and tunes to the acquired frequency band, broadcast contents can be viewed while the frequency band of the CATV cable is effectively used. In addition, by changing the currently used frequency band to a different frequency band in cooperation with the CMTS 31, a VOD service can be received without being limited by the frequency band of the CATV cable currently used for the distribution of broadcast contents.

The IP streaming distribution method includes the communication reservation step of causing the management server 13 to provide broadcast frequency band information and setting a communicable state when the IPB 43 outputs a request to acquire a frequency band in which broadcast contents are distributed, the menu window step of providing the menu window from the navigation server 11 upon reception of the menu window from the IPB 43, and the contents distribution step of causing the CMTS 31 to distribute a broadcast content to the request source IPB 43 when the IPB 43 selects a broadcast channel from the menu window. With these steps, a content with a high viewing frequency can be distributed while the frequency band of a CATV cable is effectively used.

In addition, the IP streaming distribution method includes the step of causing the navigation server 11 to send a VOD content distribution request to the distribution server 12 when the IPB 43 selects a VOD channel from the menu window, the bandwidth reservation step of causing the distribution server 12 which has received this distribution request to transmit an RSVP message, and causing the CMTS 31 to reserve a frequency band for a contents path from a return message which the request source IPB 43 receives and returns, the step of, when this frequency band is reserved, causing the CMTS 31 to change the frequency band to a different frequency band, notifying the IPB 43 of the frequency change, and notifying the distribution server 12 of the reservation of the frequency band, and the VOD contents distribution step of causing the distribution server 12 to distribute a VOD content to the IPB 43 on the basis of this notification of the reservation of the frequency band. With these steps, VOD contents can be distributed without being influenced by restrictions on the frequency band of a CATV cable, thereby realizing a contents distribution method with high extensibility.

Note that the present invention is not limited to the above embodiment, and can be variously modified without departing from the spirit and scope of the invention. The present invention can be practiced in possible combinations of the respective embodiments. In this case, the respective combinations produce some effects. In addition, the above embodiment includes inventions of genus and species stages, and various inventions can be extracted by proper combinations of a plurality of disclosed constituent elements. Assume that an invention is extracted if several constituent elements can be omitted from the all the constituent elements described in “BRIEF SUMMARY OF THE INVENTION”. In this case, when the extracted invention is to be practiced, the omitted portions are properly compensated for by known conventional techniques.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An IP (Internal Protocol) streaming system which includes a user terminal which generates a viewing request for a content, and performs IP streaming of a content for the user terminal via a CATV (community antenna television) cable, comprising:
a distribution server which holds a content and distributes the content;
a management server which holds frequency band information of the CATV cable for distributing the content; and
a CMTS (Cable Modem Termination System) which has a broadcast cable interface to which a frequency band of the CATV cable is assigned in advance and distributes to the user terminal the content distributed from the distribution server.

2. An IP streaming system which includes a user terminal which generates a viewing request for a content, and performs IP streaming of a content for the user terminal via a CATV cable, comprising:
a distribution server which holds a content and distributes the content;
a management server which holds frequency band information of the CATV cable for distributing the content; and
a CMTS which has a VOD (Video On Demand) cable interface to which a frequency band of the CATV cable is assigned in advance and distributes to the user terminal the content distributed from the distribution server.

3. A system according to claim 2, wherein
the distribution server includes frequency checking means for, when a viewing request for a VOD content is generated from the user terminal, checking an operating frequency currently used by the user terminal, which has generated the viewing request, by using an RSVP (Resource Reservation Protocol) message, and
the CMTS includes means for, on the basis of a check result on the operating frequency of the user terminal which is obtained by the distribution server, assigning a frequency different from the checked operating frequency to the VOD cable interface, and distributing the VOD content distributed from the distribution server to the user terminal which has generated the viewing request.

4. A system according to claim 3, wherein the CMTS assigns an operating frequency to the VOD cable interface on the basis of a reception content of an RSVP message from the user terminal with respect to an RSVP message from the distribution server.

5. A network router installed between distribution servers which hold and distribute broadcast contents and VOD contents and user terminals which receive the content distributed from the distribution servers via CATV cables, comprising:
a broadcast cable interface which is assigned a frequency band for distributing the broadcast content;
a VOD cable interface which is assigned a frequency band for distributing the VOD content;
first distribution means for distributing the broadcast content distributed from the distribution server in advance to the user terminal, on the basis of a viewing request from the user terminal, to the user terminal which has generated the viewing request via the broadcast cable interface; and
second distribution means for, when a viewing request for a VOD content is generated from the user terminal, assigning the VOD cable interface a frequency band different from an operating frequency band of the user terminal which has generated the viewing request which has been checked by the server, and distributing the VOD content to the user terminal, which has generated the viewing request, via the VOD cable interface.

6. A set-top box in an IP streaming system including a distribution server which holds a content and distributes the content, a management server which holds frequency band information of a CATV cable for distributing the content, a network router, and a CATV cable, the set-top box receiving the content distributed via the network router and the CATV cable, comprising:
interface means between the set-top box and the network router;
first control means for, when the content is to be viewed by broadcasting, acquiring, from the management server, a frequency band of the CATV cable for distributing the content to be viewed by broadcasting, and tuning the interface means to the acquired frequency band; and
second control means for, when the content is to be viewed by VOD, changing a frequency band to which the interface is to be tuned to a frequency band different from a frequency set when the content is viewed by broadcasting.

7. An IP streaming distribution method in an IP streaming system which includes a distribution server which holds a content and distributes the content, a management server which holds frequency band information of CATV cables for distributing the content, a navigation server which provides a menu for the contents, a network router, a CATV cable, and a user terminal which receives the content distributed via the network router and the CATV cable, comprising the steps of:
when the user terminal generates a request to view a content by broadcasting which is held by the management server, providing frequency band information for broadcasting from the management server to the user terminal, and setting the user terminal in a state in which the user terminal can communicate with the network router on the basis of the provided frequency and for broadcasting;
when the user terminal generates a request for a menu for the content, providing the menu from the navigation server to the user terminal; and
when the user terminal designates a content to be viewed on the basis of the menu, distributing the designated content to the user terminal via the network router and the CATV cable.

8. An IP streaming distribution method in an IP streaming system which includes a distribution server which holds a content and distributes the content, a management server which holds frequency band information of CATV cables for distributing the content, a navigation server which holds a menu for the contents and provides a corresponding message, a network router, a CATV cable, and a user terminal which receives the content distributed via the network router and the CATV cable, comprising the steps of:
when the user terminal generates a request for a menu for the content, providing the menu from the navigation server to the user terminal;
when the user terminal generates a request to view a VOD content on the basis of the menu, causing the navigation server to give the distribution server a request to distribute the content;
transmitting an RSVP message from the distribution server, which has received the distribution request, to the user terminal which has generated the viewing request, and causing the network router to reserve an operating frequency band for the CATV cable on the basis of a return message returned from the user terminal which has received the RSVP message;
notifying that the network router changes a frequency band used for the user terminal to the reserved operating frequency band, and notifying the distribution server of reservation of the frequency band; and
causing the distribution server, which has received notification of reservation of the frequency band, to distribute a VOD content for which the viewing request has been received to the user terminal which has generated the viewing request.
